(19) United States
(12) Patent Application Publication
(10) Pub. No.: US 2026/0161514 A1
(43) Pub. Date: Jun. 11, 2026

(54) METHOD, ELECTRONIC DEVICE, AND COMPUTER PROGRAM PRODUCT FOR BACKING UP DATA

(71) Applicant: DELL PRODUCTS L.P., ROUND ROCK, TX (US)

(72) Inventors: Weibing ZHANG, Beijing (CN); Junan FU, Beijing (CN); Huan CHEN, Beijing (CN)

(21) Appl. No.: 19/017,107

(22) Filed: Jan. 10, 2025

(30) Foreign Application Priority Data
Dec. 9, 2024 (CN) 202411803200.0

(51) Int. Cl. G06F 11/14; H04L 67/1097

(52) U.S. Cl. CPC G06F 11/1464; H04L 67/1097

(57) ABSTRACT

A method for backing up data includes determining, based on storage information of data stored in a primary storage system, tiering information of the data. The method further includes determining, based on the tiering information, storage locations corresponding to target data for backing up and backup data corresponding to the target data, where the storage locations are located in a cloud end server communicated with the primary storage system. The method further includes controlling, based on the storage locations, the cloud end server to store the backup data to a corresponding tier in the cloud end server. In this way, the tiering information can be introduced during a backup process, enabling a backup storage system to directly acquire storage information of data and store the storage information in a corresponding tier, so as to save storage cost for users while ensuring security and availability of the data.

### TECHNICAL FIELD

The present disclosure relates to the field of communication technologies, and more specifically, to a method, an electronic device, and a computer program product for backing up data.

### BACKGROUND

During use of electronic devices by users, as the scale of services for the users continues to increase, the amount of stored data will also grow exponentially. Specifically, the development of cloud computing, the Internet of Things, social networking, mobile Internet, and other technologies has led to explosive growth of data types and scales in various fields. During the storage, transmission, and exchange of data, it is necessary to ensure the security and reliability of large-scale data storage or transmission processes to prevent data loss or damage.

### SUMMARY OF THE INVENTION

Embodiments of the present disclosure provide a method, an electronic device, and a computer program product for backing up data.

In a first aspect of the present disclosure, a method for backing up data is provided. The method includes determining, based on storage information of data stored in a primary storage system, tiering information of the data. The method further includes determining, based on the tiering information, storage locations corresponding to target data for backing up and backup data corresponding to the target data, where the storage locations are located in a cloud end server communicated with the primary storage system. The method further includes controlling, based on the storage locations, the cloud end server to store the backup data to a corresponding tier in the cloud end server.

In a second aspect of the present disclosure, an electronic device is provided, including a processor; and a memory coupled to the processor and having instructions stored therein, where the instructions, when being executed by the processor, enable the electronic device to execute actions including: determining, based on storage information of data stored in a primary storage system, tiering information of the data; determining, based on the tiering information, storage locations corresponding to target data for backing up and backup data corresponding to the target data, where the storage locations are located in a cloud end server communicated with the primary storage system; and controlling, based on the storage locations, the cloud end server to store the backup data to a corresponding tier in the cloud end server.

In a third aspect of the present disclosure, a computer program product is provided. The computer program product is tangibly stored on a computer readable medium and includes machine executable instructions, and the machine executable instructions, when being executed, implement the method according to the first aspect of the present disclosure.

It should be understood that the content described in the Summary of the Invention section is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above-mentioned and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 shows a schematic diagram of an example environment in which multiple embodiments of the present disclosure can be implemented therein;

FIG. 2 shows a schematic diagram of a flow for backing up data according to some embodiments of the present disclosure;

FIG. 3 shows a schematic diagram of determining tiering information of data according to some embodiments of the present disclosure;

FIG. 4 shows a schematic diagram for restoring data according to some embodiments of the present disclosure;

FIG. 5 shows a schematic diagram for backing up files according to some embodiments of the present disclosure;

FIG. 6 shows a work flowchart for backing up data according to some embodiments of the present disclosure;

FIG. 7 shows a block diagram of an apparatus for backing up data according to some embodiments of the present disclosure; and

FIG. 8 shows a block diagram of a device that can implement multiple embodiments of the present disclosure.

### DETAILED DESCRIPTION

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may also be included below.

As stated above, a data storage process requires a large number of hardware devices and infrastructure, which not only increases investment costs but also occupies a significant amount of physical space. Moreover, with the continuous growth of data volume, the maintenance and updating of hardware devices have also become a problem. In relevant technologies, data can be backed up in cloud storage to save storage cost. It can be understood that there are significant differences in the service value and access frequency of different data, as well as different requirements for storage media. For example, compared with cold data such as historical archive data and retained record data that require long-term storage and do not require frequent access and processing, hot data with high access frequency and that is more critical to services and applications usually requires fast and efficient access and processing, and therefore, requires higher performance for storage media. And how to create different storage areas for different types of data in cloud storage has become a crucial factor.

In this regard, embodiments of the present disclosure provide a method for backing up data. In the embodiments of the present disclosure, the method includes determining, based on storage information of data stored in a primary storage system, tiering information of the data. The method further includes determining, based on the tiering information, storage locations corresponding to target data for backing up and backup data corresponding to the target data, where the storage locations are located in a cloud end server communicated with the primary storage system. The method further includes controlling, based on the storage locations, the cloud end server to store the backup data to a corresponding tier in the cloud end server.

In this way, the primary storage system and a backup storage system can be combined. The tiering information of the data can be determined according to the storage information (a storage layer where the data is located, a temperature value, a storage area, and correlation information with other data blocks) of the data in the primary storage system. Therefore, the tiering information of the data can be retained when the cloud end server is used for backing up data to enable the cloud end server to make reasonable backup strategies by means of the tiering information and choose appropriate storage locations, so as to save unnecessary cost for users while ensuring security and availability of the data.

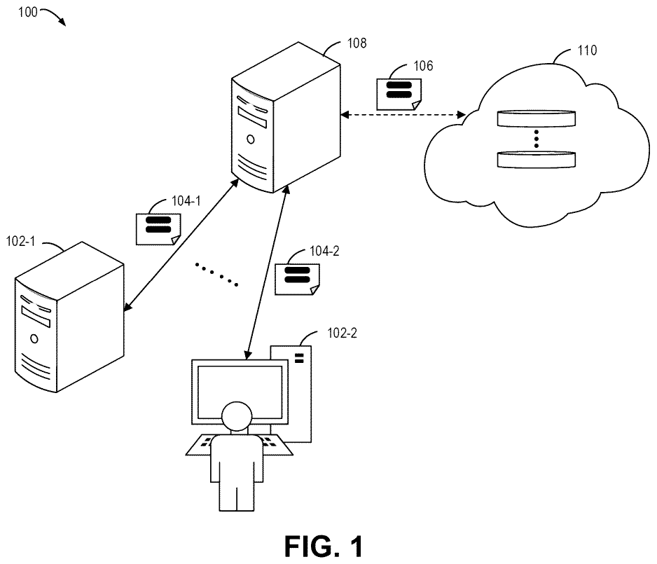

FIG. 1 shows a schematic diagram of an example environment 100 in which multiple embodiments of the present disclosure can be implemented. As shown in FIG. 1, in the example environment 100, a primary storage system 102 requiring backing up of data (which may include, but is not limited to a server 102-1 and a user end 102-2), target data 104-1 for backing up, target data 104-2, and backup data 106 are included. In the example environment 100, a cloud end server 108 in communication with the primary storage system 102 and cloud end storage space 110 corresponding to the cloud end server 108 are further included. The primary storage system 102 is not limited to the server 102-1 and the user end 102-2 shown in the example environment, and may further include, but is not limited to, personal computers, server computers, handheld or laptop devices, mobile devices, multiprocessor systems, consumer electronic products, wearable electronic devices, smart home devices, minicomputers, mainframe computers, edge computing devices, and distributed computing environments including any of the above systems or devices.

In some embodiments, the cloud end server 108 can be a service delivery mode where users can conveniently and on-demand access a shared pool of configurable computing resources (such as networks, network bandwidth, servers, processing, memory, storage, applications, virtual machines, and services) on the network. The cloud end server can include one or more cloud end storage space 110. The cloud end server 108 can be used to store data that needs to be stored at the user end 102-2 or in the server 102-1. For example, the cloud end server 108 can receive and store data uploaded by the user end 102-2. In addition, the cloud end server 108 may further support the user end 102-2 or the server 102-1 to download data stored in the cloud end server 108 from the cloud end server 108.

In some embodiments of the present disclosure, the primary storage system such as the user end 102-2 may include a memory and a storage medium. A memory can be divided into multiple storage areas. There may be multiple memories and storage media, and the types of multiple memories or storage media can be the same or different, for example, including but not limited to main memories such as a Random-Access Memory (RAM) and a Static Random-Access Memory (SRAM), an auxiliary memory or a Cache, etc. The storage media can include a Hard Disk Drive (HDD), a Solid State Drive (SSD), a magnetic disk, and an optical disk etc. It can be understood that due to different types of data, the importance of data is also different, and in order to meet the storage needs of different data, multiple storage tiers can be divided in the primary storage system 102, such as tier 1, tier 2, tier 3, etc. One tier can include multiple storage areas. Different storage tiers correspond to different storage states. The storage state refers to a storage capacity (such as a remaining capacity), a read/write speed, storage performance, etc. of a storage tier.

In some embodiments of the present disclosure, the primary storage system 102 can use a tiering storage architecture to store data by tiering based on its service value or importance. For example, data can be sorted based on the access frequency of users and applications, and data in different sorting orders can be assigned to different tiers in the primary storage system 102. In an example, the technology of Full Automated Storage Tiering for Virtual Pools (FAST VP) can be used to monitor data access patterns in a system pool and dynamically match the performance requirements of the data determined by the access patterns with the memory or storage medium that provides the performance level. For example, high-capacity Serial Attach SCSI (SAS) or NL-SAS in serial connection can be used as low-level memories to reduce the cost of storage systems; and using high-speed solid-state drives as high-level memories. In some embodiments, when creating different storage tiers, a user can specify a tier strategy, which determines which storage tier of the primary storage system different data will be placed in. The tiering strategy can be a tiering principle set by the user, for example, determining, according to the category, volume, access frequency, and confidentiality level of data, which storage tier of the primary storage system the data is stored in.

It can be understood that data may be lost or damaged due to various reasons (such as hardware failures, data damage, or malicious attacks) during storage, transmission, and exchange. On the other hand, with the usage by users, data is growing at an explosive rate, and the storage capacity and performance of the primary storage system cannot meet the needs of users. Some data have high service values and are frequently accessed by users, which is crucial for the continuity and efficient operation of the service. But some data indicates that it needs to be archived and stored for a long time, and users will hardly access it. These data have been stored in the primary storage system for a long time, which not only causes waste of storage resources and delays in the storage system's response, but also increases the storage cost of the data. Therefore, backup of data is particularly important. In some embodiments of the present disclosure, data can be backed up from the primary storage system 102 to the cloud end server 108. It can be understood that cloud end storage has high availability and scalability, and users can adjust the storage capacity according to their needs without the need to install additional hardware facilities or bear additional hardware maintenance costs. On the other hand, cloud end storage also has higher security and recoverability. When the primary storage system experiences data damage or loss due to sudden hardware failures, natural disasters, or human sabotage, it can quickly retrieve or repair data from cloud end storage, improving the disaster recovery and security performance of the primary storage system.

As shown in FIG. 1, in order to ensure the reliability, reversibility, and security of data storage, the primary storage system 102 can back up data to the cloud end server. The cloud end server, as an auxiliary storage system, can be deployed to the Power Protect Data Domain Virtual Edition (DDVE). The long-term retention feature of DDVE can help users move infrequently accessed data from data centers to cloud storage to reduce costs. However, the tiering information of the data is stored in the primary storage system 102, and the cloud end server 108 cannot know the tiering information or determine the importance level of the data to be backed up. As a result, during the backup process, all data, whether important or unimportant, are intermingled, making it impossible to perform tiered backup of the data. This leads to users having to pay the same fee for all data storage, increasing unnecessary storage costs.

In view of this, in some embodiments of the present disclosure, after receiving the target data 104 for backup from the primary storage system 102, the cloud end server 108 can determine the corresponding storage location of the backup data 106 in the cloud end storage space 110 according to the tiering information carried by the data. For example, for data with high access frequency that is crucial to services and applications, it can be stored on a high-performance, low-latency storage tier for rapid and efficient access and processing. For data that requires long-term storage but does not require frequent access and processing, it can be stored in a lower-cost and larger-capacity storage tier.

In this way, the tiering information of the data is added to the data backup process, so that the cloud end server used for backup can directly obtain the storage information of the data, determine the storage locations of the data, and store them separately in the corresponding tiers. This not only optimizes the utilization of storage resources, but also significantly reduces storage costs. Backing up data through the tiering information of the data enhances the flexibility and speed of data backup, ensuring the security and availability of the data.

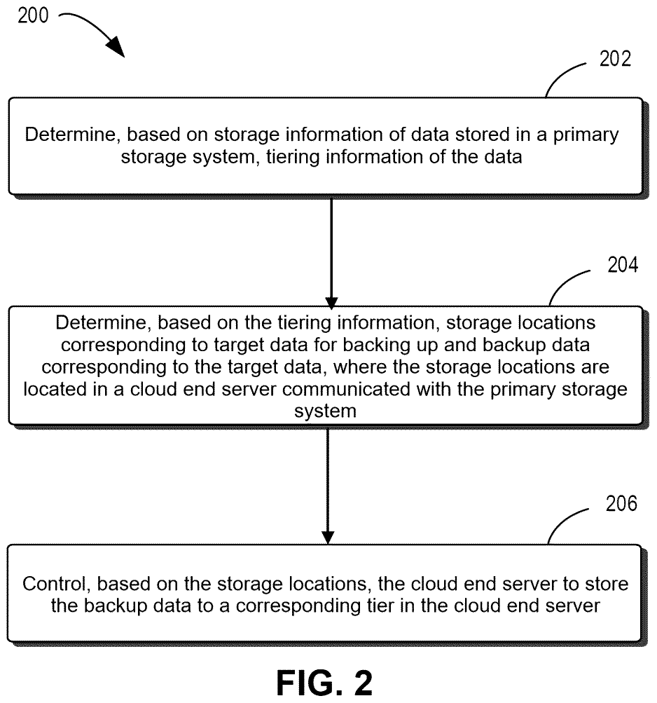

FIG. 2 shows a flowchart of a method 200 for backing up data according to some embodiments of the present disclosure. The method 200 can be executed by a cloud end server 108 shown in FIG. 1. The method 200 for backing up data according to the embodiments of the present disclosure is currently described with reference to FIG. 2. To facilitate understanding, the specific examples mentioned in the following text are all exemplary and are not used to define the protection scope of the present disclosure. As shown in FIG. 2, in a block 202, the method 200 may include determining, based on storage information of data stored in a primary storage system, tiering information of the data, where the primary storage system is a system of a user end or a serve end to storage data. The data can be service data such as program data, log data, and so on, for example, the data can include data (database files, log files, and configuration files) generated when users are using various applications.

In some embodiments, the primary storage system may be divided into multiple tiers. Different tiers correspond to different storage states, for example, different tiers correspond to different storage performance. It can be understood that storage tiers correspond to different storage scopes in the primary storage system, for example, a start position and an end position of a storage tier 1 are different from those of a storage tier 2. Taking the storage performance as an example, a tier can be classified as a high-performance tier, a low-performance tier, and a medium-performance tier. Different types of data can be stored into different tiers to meet the storage needs of different types of data. For example, for data that users do not need frequent access, the data can be stored into the low-performance tier; for data that users need frequent access, the data can be stored into the high-performance tier so as to meet efficient access needs of the users.

It can be understood that a series of storage information may be generated during a process of storing data by the primary storage system, including data files themselves and relevant metadata, for example, actually stored data content (including but not limited to text, image, audio, video, etc.), an encoding approach and organization structure of data, a physical location (a file path, a disk sector, etc.) of data on a storage device, access control information of data (including but not limited to user permission, role permission, etc.), and so on. In some embodiments, the storage information may further include a storage tier of the primary storage system where the data is located and a data type or data category corresponding to the data.

In a block 204, the method 200 may include determining, based on the tiering information, storage locations corresponding to target data for backing up and backup data corresponding to the target data, where the storage locations are located in a cloud end server communicated with the primary storage system. As stated above, the primary storage system may monitor an access mode of data and allocate data of different access frequencies to different storage tiers according to a preset tiering strategy. With use of various applications and webpages by users, a large amount of data will be generated. Some data is frequently accessed, which is crucial to the continuity and efficient operation of the service; some data has low access frequencies, but needs to be stored in long term. It can be understood that the primary storage system has limited storage space and performance resources. To save storage resources on the premise of meeting the storage needs of users, partial data such as some important data can be stored in the primary storage system, while the other data such as unimportant data can be stored in the cloud end server. Alternatively, to ensure the storage reliability and security of the important data, some important data can be stored into the cloud end server by means of backing up. In addition, data in the primary storage system may be lost due to various reasons (such as hardware default, data damage, or malicious attack). In this case, all the data in the primary storage system can be backed up, and original data can be restored after data loss by means of backing up so as to ensure the service continuity and data integrity.

It can be understood that the extension of traditional hard disk storage is often limited by physical hardware, and increasing storage capacity may require the purchase of additional hardware devices and involve complex installation and configuration processes. Moreover, the initial investment cost may be high, and when facing large capacity storage, users need to pay higher storage fees. On the other hand, traditional hard disk storage also faces the risk of single point failure. Once the hard disk is damaged or lost due to natural disasters or human damage, data may not be recoverable, causing significant losses to user usage and service continuity. On such basis, data can be backed up using the cloud end server that communicates with the primary storage system. The cloud end storage has high scalability, and users can dynamically adjust the storage capacity according to needs, without being limited by physical hardware or having to bear additional hardware maintenance costs. The cloud end storage can also provide more advanced data management functions and different levels of storage services. Different storage types can be chosen according to the access frequency and importance of data so as to achieve cost optimization. Furthermore, the cloud end storage provides stronger disaster recovery capabilities, and by storing data in multiple data centers located in different geographical locations, rapid data recovery and service operation recovery are ensured in the event of a disaster.

In some embodiments of the present disclosure, to ensure backup data of different data on the basis of saving storage resources, different backup areas or backup tiers can be divided in the cloud end server, such as a backup tier 1, a backup tier 2, and a backup tier 3. The storage performance and storage reliability of different backup tiers vary, which can meet the backup needs of different data. It should be noted that the way the cloud end server divides its tiers and the divided backup tiers are similar to the way the primary storage system divides its tiers, with the resulting storage tiers corresponding to the backup tiers. For example, the storage tier 1 and the backup tier 1 can be high-performance tiers used to store data with high access frequency or high service value.

On such basis, when acquiring data to be backed up from the primary storage system, the cloud end server can determine, based on the tiering information, a backup tier or a backup area corresponding to the data and store the data of different tiers in the primary storage system to corresponding backup tiers in the cloud end server. For example, for data that requires frequent access and has high service value, it can be stored in a backup tier with an active layer, which typically has high performance and availability to ensure that the data can be accessed rapidly. For data that is not frequently accessed but requires long-term storage, it can be stored in a backup tier with an archive layer, which typically has low costs and high capacity to save storage costs. By classifying and storing data, it helps users save costs and improve storage efficiency.

In a block 206, the method 200 may include controlling, based on the storage locations, the cloud end server to store the backup data to a corresponding tier in the cloud end server. As stated above, the tiering information of the data can indicate a storage area of the data in the primary storage system as well as a storage location of the data in the cloud end server. In some embodiments, the cloud end server can rapidly determine, based on a preset backup storage strategy, the storage location of the data based on the tiering information of the data and store the data to a corresponding tier.

In this way, the tiering information of the data can be queried and delivered during a backup process. Based on the tiering information of the data, the cloud end server can rapidly and accurately allocate different types of data to corresponding storage areas, thereby optimizing use of storage resources, avoiding long-term occupancy of efficient storage space by unimportant data, and reducing storage cost.

In some embodiments, the primary storage system can adopt a FAST VP tiering strategy to monitor a data access mode (including but not limited to tracking key indexes such as read, write, and the access frequency of the data) in a system pool. The data is divided into different performance requirement levels according to data access modes, and the data is stored to different tiers according to the performance requirement levels of the data. On such basis, tiers where the data is located, the performance requirement levels corresponding to the data, or other information of the data can be determined according to the storage locations of the data.

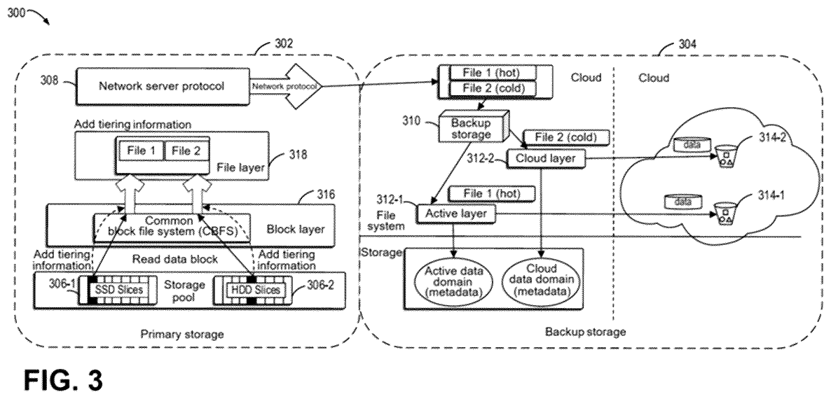

FIG. 3 shows a schematic diagram of determining tiering information of data according to some embodiments of the present disclosure. As shown in FIG. 3, in an example environment 300, a primary storage system 302 and a backup storage system 304 are included. The primary storage system 302 may be responsible for storing user data and have a function of automatic tiering storage of data. The primary storage system 302 can determine the tiering information of the data according to a data feature of the data and a resource tiering strategy and allocate the data into different storage areas according to storage tiers indicated by the tiering information, where the data feature mainly includes an access frequency, an importance degree, and a service value.

In some embodiments of the present disclosure, an access frequency threshold can be preset according to an actual tiering strategy or specific requirements. On such basis, a temperature category of the data can be determined by a comparison result of an access frequency of the data and a preset access frequency threshold. For example, data with an access frequency greater than the preset access frequency threshold can be referred to as hot data, while data with an access frequency less than the preset access frequency threshold can be referred to as cold data. It can be understood that data that requires frequent access and has high service value is hot data (such as real-time analysis data, website access logs, payment records on e-commerce platforms, etc.). These data require rapid response and efficient access, so they are typically stored on high-performance storage tiers such as Solid State Drives (SSDs) or high-performance SAS hard disks. Low access frequency or relatively low service value data is cold data (such as archived log files, infrequently used application data, etc.), which typically does not require rapid response and can be stored at low cost storage tiers such as NL-SAS hard disks, tape libraries, or cloud storage services.

In order to rapidly process a large amount of data, the primary storage system 302 can develop a tiering storage strategy and choose the corresponding storage location based on the type of data. In some embodiments of the present disclosure, the primary storage system can calculate the temperature of data based on storage pool configuration information and IO statistics information, and allocate it to the corresponding storage area (such as storing hot data in a high-performance layer 306-1 and cold data in a low-cost layer 306-2). Specifically, the primary storage system can determine an activity level of data by tracking and counting the read and write IO volume of data. Based on the information obtained from statistics and by performing weighted calculation of statistical data at a certain time frequency, the temperature of the data (such as whether it belongs to cold data or hot data) can be determined. In some examples, data with higher activity levels can be considered as data accessed more frequently, and therefore can be considered as hot data.

In some embodiments of the present disclosure, a block layer 316 in the primary storage system 302 can determine a storage tier of data based on the storage information such as the access popularity and the read/write mode of data, and then add corresponding tiering information to the data using a management mechanism of a file layer 318. For example, for frequently accessed data, it can be marked as hot data and suitable for storage in an active layer; for infrequently accessed data, it is marked as cold data and suitable for storage in a cloud layer or other low-performance storage layers. In some embodiments, the tiering information of the data can be identified by extending file attributes corresponding to the data. The backup storage system can directly determine the storage location of the backup data in the backup storage system based on the identification information of the data. In other embodiments, a metadata manager or database can also be utilized to track and record the tiering information of each data block, facilitating quick retrieval and updating of the tiering information during data backup. During the process of data being read from the primary storage system and sent to the backup storage system, the tiering information can also be transmitted by embedding it in a data path to ensure that the tiering information can be correctly transmitted to the backup storage system along with the data. To ensure the correct transmission of data, the primary storage system 302 can migrate the data and corresponding tiering information to the backup storage system 304 through an appropriate protocol path 308.

In some embodiments of the present disclosure, in order to efficiently manage and optimize storage resources, while ensuring that the backup needs of various types of data are met, different backup areas or backup tiers can be divided in the backup storage system. It can be understood that the storage performance of different backup areas varies, which can meet the backup needs of different types of data. After the backup storage system 304 receives the data, the backup storage processor 310 can determine a temperature category of the data according to the tiering information of the data and allocate it to the corresponding backup area. For example, high-performance backup areas can be chosen for data with high activity levels (a storage bucket 314-1 corresponding to the active layer 312-1 is taken as an example in FIG. 3) in the primary storage system. For data with low access frequency in the primary storage system, a large-capacity storage area can be chosen as a backup storage location (a storage bucket 314-2 corresponding to a cloud layer 312-2 is taken as an example in FIG. 3). Cloud storage provides scalable storage space as well as data redundancy and backup services, and is suitable for storage scenarios that require high availability and flexibility. Choosing cloud storage as a backup storage system can greatly reduce storage costs and alleviate the pressure on users in terms of storage resource investment while ensuring data security and integrity.

It can be understood that the attribute information of data is not static, but changes based on factors such as its access frequency and service requirements. For example, a data block may be hot data when it is first written because a user accesses it frequently at this time, but over time, the access frequency may gradually decrease, and the data block will gradually become cold data. Similarly, a dataset that was previously rarely accessed may become important due to new service requirements or analytical tasks, thus transforming into hot data. Hot data typically requires more frequent backup and shorter restore time, while cold data can adopt longer backup cycles and lower restore priorities. But as the hot and cold attributes of the data change, it may be necessary to migrate the data from one storage layer to another, which ensures that the data is always stored on the storage device that is most suitable for its access frequency and value.

In some embodiments, in order to cope with changes in the cold and hot attributes of data, monitoring and analysis of the data can be carried out, and the tiering information of the data can be updated regularly. A data migration strategy is further made to timely migrate data from the current storage location to the storage location corresponding to the updated tiering information according to the updated tiering information obtained from the primary storage system 302. For example, the backup storage system 304 retrieves the updated tiering information from the primary storage system 302, indicating that the current data has transitioned from cold data to hot data with high access frequency. Therefore, the backup storage system 304 migrates data from the storage bucket 314-2 corresponding to the current cloud layer 312-2 to the storage bucket 314-1 corresponding to the active layer 312-1 with higher performance and convenient access at any time. During the backup process, it is necessary to make backup and migration strategies based on the hot and cold attributes of the data. By implementing these strategies and methods, it is possible to effectively manage hot and cold data, improve storage efficiency, reduce costs, and meet constantly changing service needs.

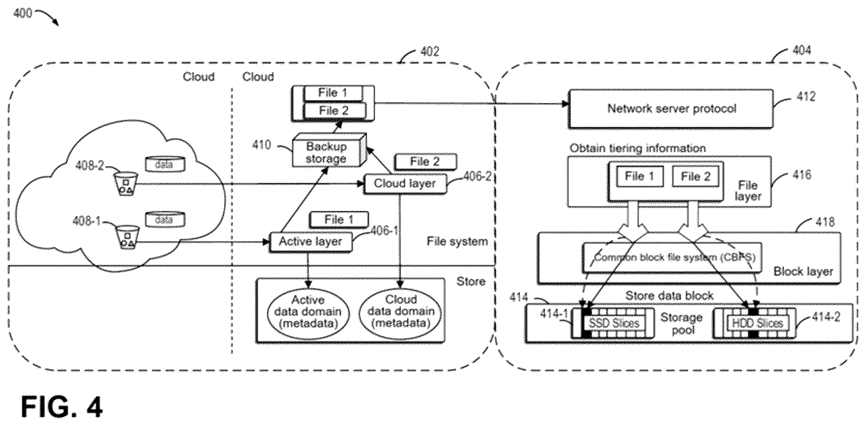

FIG. 4 shows a schematic diagram for restoring data according to some embodiments of the present disclosure. As shown in FIG. 4, in an example environment 400, a backup storage system 402 and a primary storage system 404 are included. The backup storage system 402 is located in a cloud end server, and storage resources of the backup storage system 402 are cloud resources purchased according to needs. Data restoration refers to restoring data stored in the backup storage system 402 to an initial location or a designated location of the primary storage system 404.

It can be understood that data may be lost, damaged, or erroneous during the process of generation, transmission, storage, and application due to hardware failures, software errors, malicious attacks, or perceived operational errors. Data restoration can restore damaged or deformed original data, ensuring service continuity and data integrity, and reducing losses caused by data loss. When data restoration is required, a data restoration request is usually triggered automatically by a user or the primary storage system. In some embodiments, the restoration request sent by the primary storage system 404 specifies the data that needs to be restored. Similar to the backup process, the restoration process is also performed based on the tiering information of the data. The backup storage system 402 can determine, according to the restoration request, which data needs to be restored, and determine the storage information corresponding to the data to be restored, such as which backup tier the data is located in.

For example, to-be-restored file 1 can determine, based on the restoration request, that the to-be-restored data is data with high service value and frequent access, and the original data corresponding to the data is stored in an active layer 406-1 of the backup storage system 402. A to-be-restored file 2 can determine, according to the restoration request, that it is stored in a cloud layer 406-2 of the backup storage system. As shown in FIG. 4, different tiers of data are stored in different storage areas, so the restoration processes can be carried out in parallel, thereby improving restoration efficiency. A backup storage processor 410 reads data from the corresponding storage areas according to the request. For example, the data corresponding to file 1 is stored in a storage area 408-1 corresponding to the active layer, and the data corresponding to file 2 is stored in a storage area 408-2 corresponding to the cloud layer.

In some embodiments, the backup storage system 402 transfers data to the primary storage system 404 through an appropriate protocol layer 412. Choosing an appropriate protocol layer is crucial to ensure the integrity and security of data. For example, for data that needs to be encrypted for transmission, security protocols such as HTTPS can be prioritized, providing encryption protection for data transmission to prevent data theft or tampering. In addition, in order to optimize transmission efficiency and performance, specific protocol layer configurations may be selected based on the characteristics of the data and transmission requirements, such as adjusting the size of the transmission buffer, setting timeout time, etc. It can be understood that the protocol layer ensures that data is not damaged or lost during transmission through a series of error detection and correction mechanisms. For sensitive or important data, the protocol layer provides encryption and authentication functions to ensure that the data can only be accessed by authorized users or systems. In other embodiments, in addition to relying on protection of the protocol layer, other measures can be taken to enhance data integrity and security. For example, data check code (such as hash values) is used to verify the integrity of data. For particularly important data, redundant or backup transmission can also be used to ensure quick recovery even in the event of errors during transmission.

In some embodiments of the present disclosure, after receiving the to-be-restored data, the primary storage system 404 can determine a storage location of the data in a storage pool 414 according to the tiering information at a file layer 416, and store the data in the corresponding storage location. For example, file 1 is stored into 414-1 (SSD is taken as an example in FIG. 4) with a faster read/write speed and higher performance based on the tiering information, while file 2 is determined to be at the storage location 414-2 (HDD is taken as an example in FIG. 4) with a slower read/write speed but larger storage capacity according to the tiering information. It can be understood that in order to ensure that the data is correctly restored to the original storage location or specified location, it is also necessary to verify whether the restoration result is correct. For example, after data restoration, it is necessary to compare the restored file content with the original file content. The hash value of the original file can be calculated, and the hash value of the restored file is then calculated again after data restoration. If two hash values are the same, it indicates that the file content has not been tampered with or damaged during the restoration process. For files with metadata, it is necessary to verify whether the metadata is correctly restored during the restoration process. The metadata may include permission settings and owner information of the files. After verification and confirmation that the data is intact and correct, the restoration process ends and the data can continue to be read and used.

In some embodiments of the present disclosure, a Common Block File System (CBFS) in a block layer 418 is used in some data restoration processes. The CBFS is responsible for managing data blocks and can divide data into data blocks with fixed sizes for storage. For example, when storing a large number of files, the CBFS can divide the files into data blocks, which can be more flexibly allocated to different storage media (such as 414-1 (SSD Slices) and 414-2 (HDD Slices)), thereby optimizing the utilization of storage resources. The CBFS can also adopt some data protection mechanisms, such as data redundancy, error correction codes, and other technologies. In the process of storing data blocks, adding redundant data blocks or error correction codes can restore data in the event of partial data block damage, ensuring data integrity and reliability.

In this way, in the event of data loss, damage, or the need for migration, upgrade, etc., data can be quickly restored through data restoration operations, ensuring the integrity, continuity, and security of the data. Meanwhile, data types that need to be restored, such as critical service data, sensitive data, historical data, and backup data, can also be properly protected and managed.

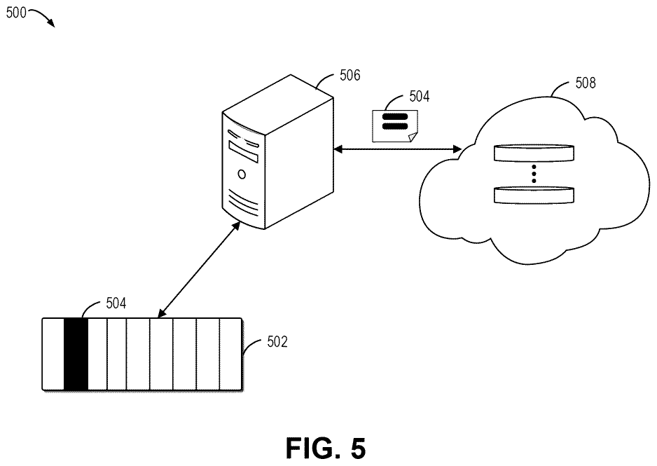

FIG. 5 shows a schematic diagram for backing up files according to some embodiments of the present disclosure. As shown in FIG. 5, an example environment 500 includes a file 502, a primary storage system 506, and a backup storage system 508. It can be understood that when the file volume is large, it often presents complex and diverse data access characteristics. Taking large media files as an example, during a playback process of a video file, the beginning part may have a high access frequency due to frequent previews, jumping to specific segments, and other operations by users, which belongs to the hot data part; the large amount of routine plot content in the middle, which has a relatively low frequency in daily access, can be classified as the cold data part. For large-scale design drawing files at the enterprise level, frequently modified areas during a design process are frequently accessed during the project and are hot data; the subsequent traffic to the confirmed infrastructure part is sharply decreased, which becomes cold data. If the entire file is stored uniformly as hot data, storing the entire file in a high-performance storage medium with high cost in order to meet the access speed of hot data will result in waste of storage resources and a sudden increase in cost. If the entire file is stored in a low-cost medium to save costs, it will result in high access latency to the hot data section, affecting service efficiency.

In some embodiments, to achieve balance between the storage performance and cost, a preset file size threshold can be preset based on actual storage or backup requirements. If a file size of the file 502 is greater than a preset threshold, the file 502 can be divided into multiple sub-files (such as a sub file 504). Different sub files are stored in different tiers of the primary storage system based on the hot/cold degree or access requirements of the data contained in the sub file 504. For example, regarding the large video files mentioned above, the portion of the header that is frequently previewed and accessed by users is marked as hot data (stored in high-performance storage layers), while the less frequently accessed regular content in the middle is marked as cold data (stored in high-capacity storage layers). On such basis, the storage information corresponding to a file 502 includes storage locations and storage tiers corresponding to all sub files 504. The storage information is sent to the cloud end server, and the cloud end server can store the file 502 to be backed up in the form of sub files and store the multiple sub files to different backup tiers of the cloud end server based on the storage information.

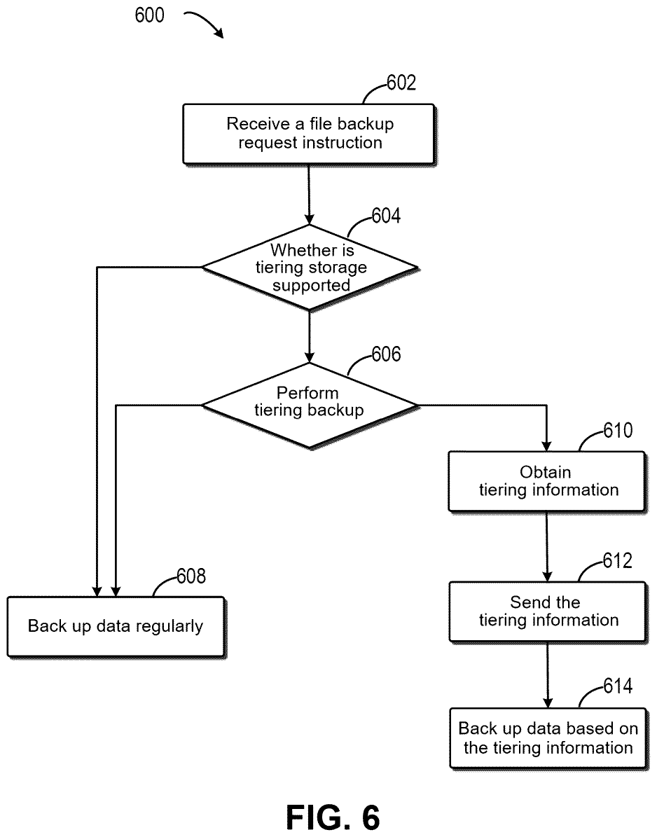

FIG. 6 shows a work flowchart for backing up data according to some embodiments of the present disclosure. As shown in FIG. 6, in a block 602, a cloud end server may receive a backup request instruction sent by a primary storage system, where the backup request instruction may include data that needs to be backed up in the primary storage system and whether the data includes tiering information. At a block 604, in response to the backup request instruction, the cloud end server may determine whether the primary storage system is divided into multiple storage tiers and whether different types of data such as cold and hot data is stored in different storage tiers. At a block 606, in a case where it is determined that the primary storage system supports tiering storage of data, it can be determined whether to adopt a tiering backup method for the backup data.

As shown in FIG. 6, at a block 608, in a case where it is determined that the primary storage system does not support the data tiering storage approach, the data stored in the primary storage system can be backed up to the cloud end server according to a preset backup frequency, for example, backed up to DDVE. At a block 610, in a case where it is determined that the primary storage system supports the data tiering storage approach and applies the tiering backup approach to the backup data, tiering information corresponding to the data (i.e., the storage tiers in which the data is stored and the cold and hot categories of the data) can be acquired from the primary storage system. It can be understood that at a block 612, the tiering information can be carried by data, for example, the storage tiers and cold and hot categories corresponding to the data can be carried by extending file attributes of the data.

In some embodiments, at a block 614, the cloud end server such as DDVE can determine the tiering information corresponding to the data based on the extended attributes of the files. For example, the data can be cold data which can be stored at a storage tier S3. On such basis, backup data corresponding to the data can be stored at a backup tier S3 of the cloud end server based on the information.

In this way, different backup approaches can be chosen according to different situations so as to enable the backup application range of data to be wider and the backup approaches to be more flexible.

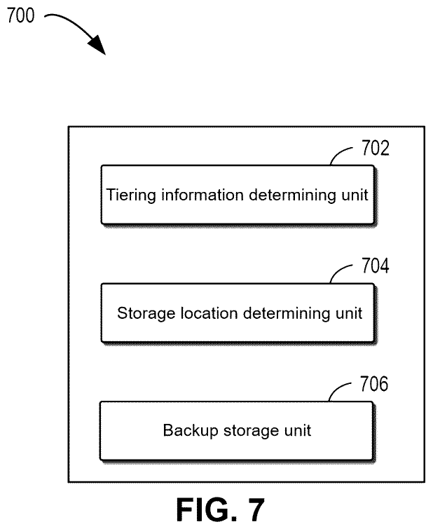

FIG. 7 shows a block diagram of an apparatus 700 for backing up data according to some embodiments of the present disclosure. As shown in FIG. 7, the apparatus includes a tiering information determining unit 702, configured to determine, based on storage information of data stored in a primary storage system, tiering information of the data. The apparatus 700 further includes a storage location determining unit 704, configured to determine, based on the tiering information, storage locations corresponding to target data for backing up and backup data corresponding to the target data, where the storage locations are located in a cloud end server communicated with the primary storage system. The apparatus 700 further includes a backup storage unit 706, configured to control, based on the storage locations, the cloud end server to store the backup data to a corresponding tier in the cloud end server.

In some embodiments, the apparatus 700 further includes a data restoring unit configured to: restore, based on the tiering information of the data, the backup data to a corresponding tier in the primary storage system.

In some embodiments, the data restoring unit is further configured to: determine, based on the tiering information, a storage location of to-be-restored backup data in the cloud end server and a storage location of the to-be-restored backup data in the primary storage system; acquire, based on the storage location of the to-be-restored backup data in the cloud end server, backup data from the cloud end server; and store, based on the storage location of the backup data in the primary storage system, the backup data into the primary storage system.

In some embodiments, the tiering information determining unit 702 is further configured to: determine the tiering information of the data based on a data feature of the data and a tiering strategy of the primary storage system.

In some embodiments, the tiering information determining unit 702 is further configured to: determine a temperature category of the data based on storage configuration information and access information of the data, where the temperature category is used to represent an activity degree of the data; and determine a tiering strategy of the primary storage system based on the temperature category of the data, where the tiering strategy includes determining a storage location of the data in the primary storage system based on the temperature category of the data.

In some embodiments, the tiering information determining unit 702 is further configured to: determine the temperature category of the data based on a comparison result of an access frequency of the data and a preset access frequency threshold; and determine, based on the temperature category of the data, the tiering information of the data and allocate a corresponding storage area to the data.

In some embodiments, the storage location determining unit 704 is further configured to: allocate, based on the tiering information of the data, a corresponding storage area to the data in the cloud end server, where the storage area includes a first storage area and a second storage area, the first storage area is used to store data with a temperature level greater than a preset temperature level, and the second storage area is used to store data with a temperature level less than the preset temperature level.

In some embodiments, the tiering information determining unit 702 is further configured to: determine corresponding attribute information based on the tiering information of the data; and extend a file attribute corresponding to the data based on the attribute information, where the extended file attribute includes the tiering information of the data.

In some embodiments, the apparatus 700 further includes a data migration unit configured to: in response to that the tiering information of the data changes, acquire updated tiering information of the data from the primary storage system; and migrate, based on the updated tiering information, the data from a current storage location to a storage location corresponding to the updated tiering information.

In some embodiments, the storage location determining unit 704 is further configured to: determine whether a file size corresponding to the data is greater than a preset file size threshold; in response to that the file size is greater than the preset file size threshold, divide a file corresponding to the data into a preset segmentation quantity of sub files based on the preset segmentation quantity; and determine storage locations of the sub files in the cloud end server based on file locations corresponding to the sub files and tiering information corresponding to the data.

It can be understood that the apparatus 700 of the present disclosure can be used to implement at least one of multiple advantages that can be implemented by the method or process as described in the above text.

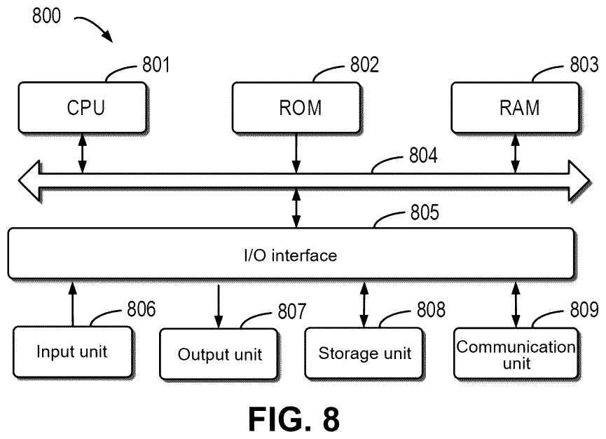

FIG. 8 shows a schematic block diagram of an example device 800 that can be used to implement the embodiments of the present disclosure. As shown in the figure, the device 800 includes a computing unit 801, which may execute various appropriate actions and processing according to computer program instructions stored in a read-only memory (ROM) 802 or computer program instructions loaded from a storage unit 808 onto a random access memory (RAM) 803. Various programs and data required for the operation of the device 800 may also be stored in the RAM 803. The computing unit 801, the ROM 802, and the RAM 803 are connected to each other through a bus 804. An input/output (I/O) interface 805 is also connected to the bus 804.

A plurality of components in the device 800 are connected to the I/O interface 805, including: an input unit 806, such as a keyboard and a mouse; an output unit 807, such as various types of displays and speakers; the storage unit 808, such as a magnetic disk and an optical disk; and a communication unit 809, such as a network card, a modem, and a wireless communication transceiver. The communication unit 809 allows the device 800 to exchange information/data with other devices via a computer network, such as the Internet, and/or various telecommunication networks.

The computing unit 801 may be various general-purpose and/or special-purpose processing components with processing and computing capabilities. Some examples of the computing unit 801 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 801 performs various methods and processes described above, such as the method 200. For example, in some embodiments, the method 200 may be implemented as a computer software program that is tangibly included in a machine-readable medium, such as the storage unit 808. In some embodiments, part or all of the computer program may be loaded and/or installed onto the device 800 via the ROM 802 and/or the communication unit 809. When the computer program is loaded to the RAM 803 and executed by the computing unit 801, one or more steps of the method 200 described above may be performed. Alternatively, in other embodiments, the computing unit 801 may be configured to implement the method 200 in any other suitable approaches (e.g., by means of firmware).

The functions described hereinabove can be performed at least in part by one or more hardware logic components. For example, non-restrictively, demonstration types of hardware logic components that can be used include Field Programmable Gate Arrays (FPGAs), Application Specific Integrated Circuits (ASICs), Application Specific Standard Parts (ASSPs), Systems On Chip (SOC), Complex Programmable Logic Devices (CPLDs), etc.

Program codes for implementing the method of the present disclosure may be written by using one programming language or any combination of multiple programming languages. The program codes may be provided to a processor or controller of a general purpose computer, a special purpose computer, or another programmable data processing apparatus, such that the program codes, when executed by the processor or controller, cause the functions/operations specified in the flow charts and/or block diagrams to be implemented. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for backing up data, comprising:
determining, based on storage information of data stored in a primary storage system, tiering information of the data;
determining, based on the tiering information, storage locations corresponding to target data for backing up and backup data corresponding to the target data, wherein the storage locations are located in a cloud end server communicated with the primary storage system;
controlling, based on the storage locations, the cloud end server to store the backup data to a corresponding tier in the cloud end server;
automatically monitoring and analyzing the data at the primary storage system on a regular basis to determine a change of the tiering information of the data;
if the change of the tiering information of the target data is determined, updating the tiering information of the data at the primary storage system; and
in response to the updated tiering information of the data, migrating, by the cloud end server, based on the updated tiering information, the target data from a current storage location to a storage location corresponding to the updated tiering information.

2. The method according to claim 1, further comprising:
restoring, based on the tiering information of the data, the backup data to a corresponding tier in the primary storage system.

3. The method according to claim 2, wherein restoring the backup data to a corresponding tier in the primary storage system further comprises:
determining, based on the tiering information, a storage location of to-be-restored backup data in the cloud end server and a storage location of the to-be-restored backup data in the primary storage system;
acquiring, based on the storage location of the to-be-restored backup data in the cloud end server, backup data from the cloud end server; and
storing, based on the storage location of the backup data in the primary storage system, the backup data into the primary storage system.

4. The method according to claim 1, wherein determining tiering information of the data comprises:
determining the tiering information of the data based on a data feature of the data and a tiering strategy of the primary storage system.

5. The method according to claim 4, further comprising:
determining a temperature category of the data based on storage configuration information and access information of the data, wherein the temperature category is used to represent an activity degree of the data; and
determining a tiering strategy of the primary storage system based on the temperature category of the data, wherein the tiering strategy comprises determining a storage location of the data in the primary storage system based on the temperature category of the data.

6. The method according to claim 4, wherein determining tiering information of the data further comprises:
determining a temperature category of the data based on a comparison result of an access frequency of the data and a preset access frequency threshold; and
determining, based on the temperature category of the data, the tiering information of the data and allocating a corresponding storage area to the data.

7. The method according to claim 6, wherein determining the tiering information of the data and allocating a corresponding storage area to the data comprises:
allocating, based on the tiering information of the data, a corresponding storage area to the data in the cloud end server, wherein the storage area comprises a first storage area and a second storage area, the first storage area is used to store data with a temperature level greater than a preset temperature level, and the second storage area is used to store data with a temperature level less than the preset temperature level.

8. The method according to claim 1, further comprising:
determining corresponding attribute information based on the tiering information of the data; and
extending a file attribute corresponding to the data based on the attribute information, wherein the extended file attribute comprises the tiering information of the data.

9. (canceled)

10. The method according to claim 1, further including:
determining whether a file size corresponding to the data is greater than a preset file size threshold;
in response to that the file size is greater than the preset file size threshold, dividing a file corresponding to the data into a preset segmentation quantity of sub files based on the preset segmentation quantity; and
determining storage locations of the sub files in the cloud end server based on file locations corresponding to the sub files and tiering information corresponding to the data; and
storing the sub files in their corresponding storage areas based on the tiering information corresponding to the data, wherein the corresponding storage areas include different storage tiers.

11. An electronic device, including:
a processor; and
a memory coupled to the processor, the memory having instructions stored therein, wherein the instructions, when executed by the processor, cause the electronic device to perform actions comprising:
determining, based on storage information of data stored in a primary storage system, tiering information of the data;
determining, based on the tiering information, storage locations corresponding to target data for backing up and backup data corresponding to the target data, wherein the storage locations are located in a cloud end server communicated with the primary storage system; and
controlling, based on the storage locations, the cloud end server to store the backup data to a corresponding tier in the cloud end server,
automatically monitoring and analyzing the data at the primary storage system on a regular basis to determine a change of the tiering information of the data;
if the change of the tiering information of the target data is determined, updating the tiering information of the data at the primary storage system; and
in response to the updated tiering information of the data, migrating, by the cloud end server, based on the updated tiering information, the target data from a current storage location to a storage location corresponding to the updated tiering information.

12. The device according to claim 11, wherein the actions further comprise:
restoring, based on the tiering information of the data, the backup data to a corresponding tier in the primary storage system.

13. The device according to claim 12, wherein the actions further comprise:
determining, based on the tiering information, a storage location of to-be-restored backup data in the cloud end server and a storage location of the to-be-restored backup data in the primary storage system;
acquiring, based on the storage location of the to-be-restored backup data in the cloud end server, backup data from the cloud end server; and
storing, based on the storage location of the backup data in the primary storage system, the backup data into the primary storage system.

14. The device according to claim 11, wherein determining tiering information of the data comprises:
determining the tiering information of the data based on a data feature of the data and a tiering strategy of the primary storage system.

15. The device according to claim 14, wherein the tiering strategy comprises:
determining a temperature category of the data based on storage configuration information and access information of the data, wherein the temperature category is used to represent an activity degree of the data; and
determining a tiering strategy of the primary storage system based on the temperature category of the data,
wherein the tiering strategy comprises determining a storage location of the data in the primary storage system based on the temperature category of the data.

16. The device according to claim 14, wherein determining tiering information of the data further comprises:
determining a temperature category of the data based on a comparison result of an access frequency of the data and a preset access frequency threshold; and
determining, based on the temperature category of the data, the tiering information of the data and allocating a corresponding storage area to the data.

17. The device according to claim 16, wherein determining the tiering information of the data and allocating a corresponding storage area to the data comprises:
allocating, based on the tiering information of the data, a corresponding storage area to the data in the cloud end server, wherein the storage area comprises a first storage area and a second storage area, the first storage area is used to store data with a temperature level greater than a preset temperature level, and the second storage area is used to store data with a temperature level less than the preset temperature level.

18. The device according to claim 11, further comprising:
determining corresponding attribute information based on the tiering information of the data; and
extending a file attribute corresponding to the data based on the attribute information, wherein the extended file attribute comprises the tiering information of the data.

19. (canceled)

20. A non-transitory computer readable medium having executable instructions stored therein, which when executed by a machine, cause the machine to perform actions comprising:
determining, based on storage information of data stored in a primary storage system, tiering information of the data;
determining, based on the tiering information, storage locations corresponding to target data for backing up and backup data corresponding to the target data, wherein the storage locations are located in a cloud end server communicated with the primary storage system; and
controlling, based on the storage locations, the cloud end server to store the backup data to a corresponding tier in the cloud end server,
automatically monitoring and analyzing the data at the primary storage system on a regular basis to determine a change of the tiering information of the data;
if the change of the tiering information of the target data is determined, updating the tiering information of the data at the primary storage system; and
in response to the updated tiering information of the data, migrating, by the cloud end server, based on the updated tiering information, the target data from a current storage location to a storage location corresponding to the updated tiering information.

21. The non-transitory computer readable medium according to claim 20, further comprising:
restoring, based on the tiering information of the data, the backup data to a corresponding tier in the primary storage system.

22. The non-transitory computer readable medium according to claim 21, wherein restoring the backup data to a corresponding tier in the primary storage system further comprises:
determining, based on the tiering information, a storage location of to-be-restored backup data in the cloud end server and a storage location of the to-be-restored backup data in the primary storage system;
acquiring, based on the storage location of the to-be-restored backup data in the cloud end server, backup data from the cloud end server; and
storing, based on the storage location of the backup data in the primary storage system, the backup data into the primary storage system.
